(19) United States
(12) Patent Application Publication
(10) Pub. No.: US 2010/0034431 A1
(43) Pub. Date: Feb. 11, 2010

(54) Signer-implemented method and system using biometric marks for avoiding fraudulent checks and documents

(76) Inventor: Joseph Joseph, New York, NY (US)

Correspondence Address: FELDMAN LAW GROUP, P.C.,, 12 East 41st Street, New York, NY, 10017, US

(21) Appl. No.: 12/228,125

(22) Filed: Aug. 11, 2008

(51) Int. Cl. G06K 9/00; B42D 15/00

(52) U.S. Cl. 382/115; 382/112; 283/58

(57) ABSTRACT

A signer-implement method and system using biometric verification for avoiding fraudulent checks and other documents is provided. The method and system includes having the document scanned, signed from an authorized signor, providing the signor with a device for adding at least one biometric mark and sending the document to an authorized receiver. The method and system also includes having the document returned for verification against the biometric mark. The method and system is applicable to a variety of documents ranging from documents such as bank checks to such as legal will, paintings, financial instruments, historical papers and diskettes.

### BACKGROUND OF THE INVENTION

### Field of the Invention

The present invention relates to a signer-implemented method and system using biometric marks for avoiding fraudulent checks that includes approving an invoice and printing a check for the approved invoice

A variety of methods and systems for preventing fraudulent checks and documents are present in the prior art. All of these methods and systems fail to provide the person who issues checks and documents with control over the verification and identification process of forged and fake document and checks and are dependent on a “third party.”

There is a need for a method and a system that provides a signer or owner of a document the power not only to decide the identification technique to be used but also the process to be followed while implementing the identification technique. Also, it is not necessary to identify the fraudulent check or a document in real time as one who issues the document and one who receives the document are known to each other. Therefore, there is need for a method and a system that is not time consuming in “real time” and which verifies the forged, fraudulent, or wrongly issued documents or checks post “real time.” Further, there is a need for a method and a system for preventing fraudulent checks and documents that is simple and cost effective.

### SUMMARY OF THE INVENTION

A signer-implemented method and system using biometric marks for avoiding fraudulent checks is provided that includes approving an invoice, printing a check for the approved invoice, getting the check signed by an authorized signatory, adding at least one biometric mark to the signed check for verification in the future and sending the check to a receiver. The method and system further includes getting the checks sent to receivers returned from the bank and verifying the veracity of the returned checks by scanning the checks for the biometric mark.

A sender-implemented method and system for providing biometric security to a document includes scanning the document, reading and approving the document, printing the document and having the document signed by an authorized sender. The method and system also includes providing the sender with a device to add biometric marks wherein the sender adds at least one biometric mark to the document, and sends the document to a receiver. The method and system further includes getting the document returned from the receivers and verifying the genuineness of the document by scanning the document for the biometric mark.

### BRIEF DESCRIPTION OF THE DRAWING

These and other aspects of the invention will become apparent from the following description read in conjunction with the accompanying drawings, in which:

FIG. 1 illustrates a flowchart of the method of the present invention;

FIG. 2 illustrates a block diagram of the method of the present invention; and

FIG. 3 illustrates a block diagram of another embodiment of the present invention.

### DETAILED DESCRIPTION OF THE INVENTION

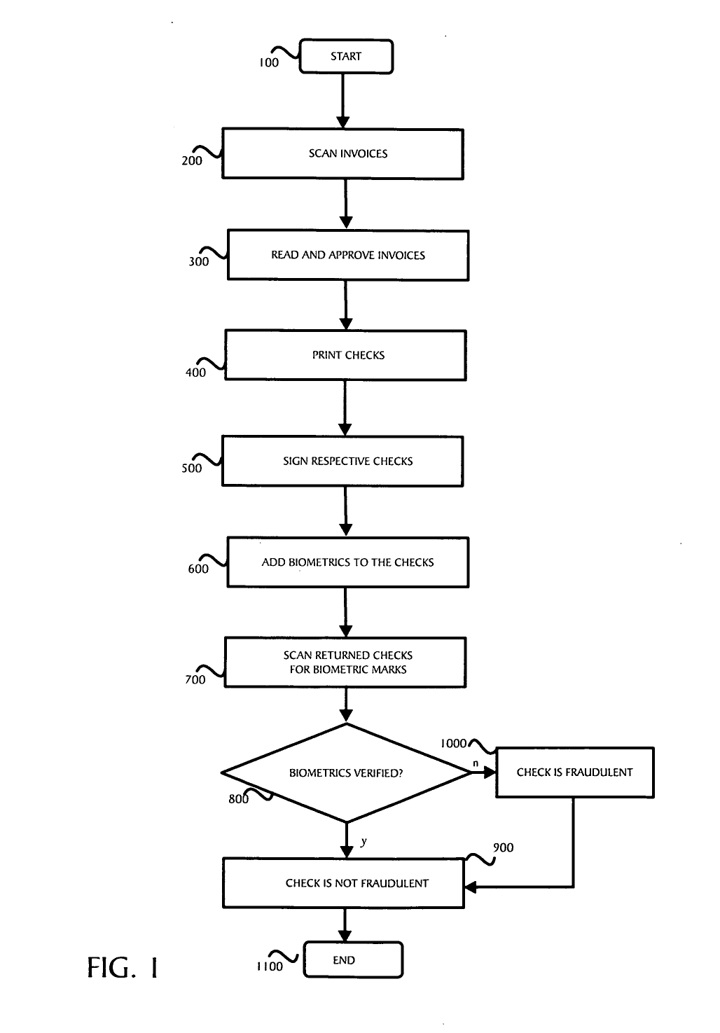

Referring to the drawings, FIG. 1 is a flowchart of the method and system of the present invention illustrating the steps followed by a sender when implementing a biometric security and verification for a check. Step 100 is the starting point. At step 200, invoices are scanned either manually by appointed staff using a document scanning apparatus or by an automatic document feeding and scanning apparatus. Next, at step 300, invoices are read and approved either manually by appointed staff or automatically by a software program and an apparatus controlled by the software program designed for automatic document processing and approval. The approval may be based upon reading the contents of the invoice for various details or serial numbers or identification marks unique to the vendor. The details may include the amount and the items listed in the invoice, the stamp or the signature of the vendor. Next, at step 400, checks of a bank are printed for approved invoices using a printer by appointed staff. The checks may also be printed using a software program and a printer controlled by the software program directly attached to the program. Next, at step 500, the checks are signed by an authorized signatory. The authorized signatory is a plurality of persons whose signs are required on checks. The authorized persons may manually sign each check. The choice of using a software program and a printer controlled by the software program that prints stored signatures of the authorized signatories may also be made available depending upon the quantity of checks to be signed. Step 600 is next where a biometric mark is added to the signed checks. The biometric mark is added by the authorized signatory preferably using an apparatus for adding a biometric mark. The biometric mark may also be added automatically by a software program and an apparatus for adding a biometric mark controlled by the software program. The apparatuses for adding biometric that are used, not only capture and add biometric marks, such as fingerprints, palm prints, but may also be capable of sequence checking for fingerprints and palm prints, for example, of biometric marks. Therefore, a single apparatus may be used for adding and identifying biometrics. Next at step 700, checks that have been returned by the bank are scanned for the biometric and the method either by the appointed staff or by an automatic document feeding and scanning apparatus or by an appointed staff using a document scanning apparatus. Next at step 800, it is determined whether the checks have biometric marks either manually by the appointed staff or by using an apparatus for verifying the biometric checks or by appointed staff using the apparatus for verifying the biometric. Biometric identification systems that match rolled images and flat impressions may be used for the purpose of biometric identification. If the checks are found to have the biometric mark by the appointed staff or the apparatus for verifying the biometric mark, the method and system of the present invention continues to step 900 where the checks are declared to be genuinely issued by the appointed staff or the automatic biometric identification system that may be used for this purpose, and the method and system ends at step 1100. If the checks are found to be without the biometric mark by the appointed staff or the automatic biometric identification system used for the purpose, the method and system continues to step 1000 where the checks are declared to be fraudulent by the appointed staff or by the biometric identification system developed for the purpose and the method and system ends at step 1100.

It should be noted that depending upon the need of the company or organization using the present invention, the verification of genuine invoices, the addition and identification of biometric marks can be effected using manual as well automatic processes or combination or manual and automatic processes. The sender can be a person who is authorized to deliver, send these documents. Also, the documents can be in various forms ranging from paper documents to CD's.

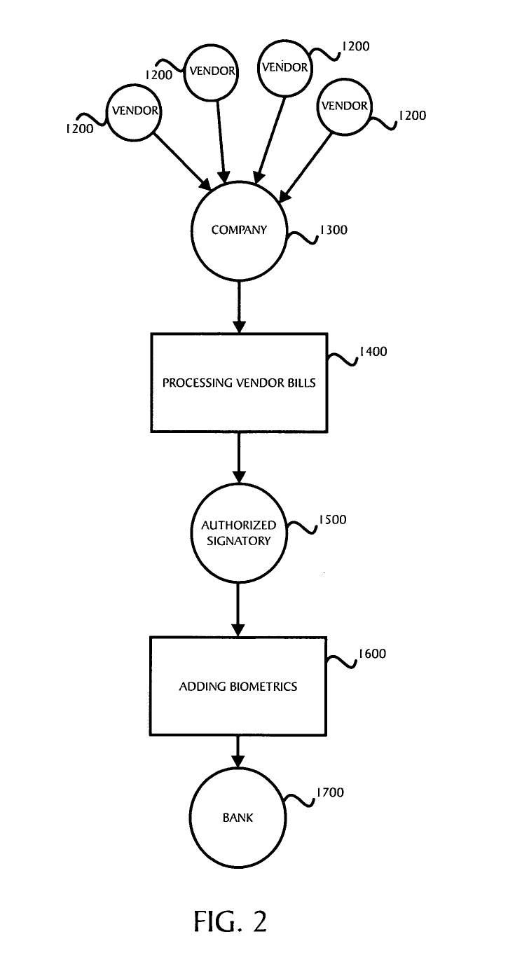

FIG. 2 shows a role based high-level block diagram of the method and system of the present invention. A cluster of vendors 1200, associated with a company 1300, submit bills for encashment. The bills received from the vendors 1200 are processed (1400) by an appropriate department, such as a Purchase Department, for example, before payment. The details mentioned in the bills are verified by the staff appointed for the purpose. After verifying the veracity of the bill details, the bills and the list of checks to be prepared are sent to the signing officer or signing authority so that payment checks can be prepared for corresponding bills. The signing officer or the signing authority is an agent of the organization appointed for the purpose of making payments and authorized to sign and issue checks for payment. The signing officers or signing authorities may sign the checks implicitly or explicitly. The authorized signatory 1500 prepares the checks according to the bills and the corresponding list of checks and adds a biometric mark to each check before the checks are sent to banks 1700 and the payment is deposited in the vendor account.

Alternatively, the checks could be sent directly to the vendors 1200 and the vendors deposit the checks in the banks 1700. Further, it should be noted that although in this preferred embodiment only one authorized signatory 1500 is assumed, the method and the system according to the present invention can take care of a plurality of authorized signatories 1500 in an organization.

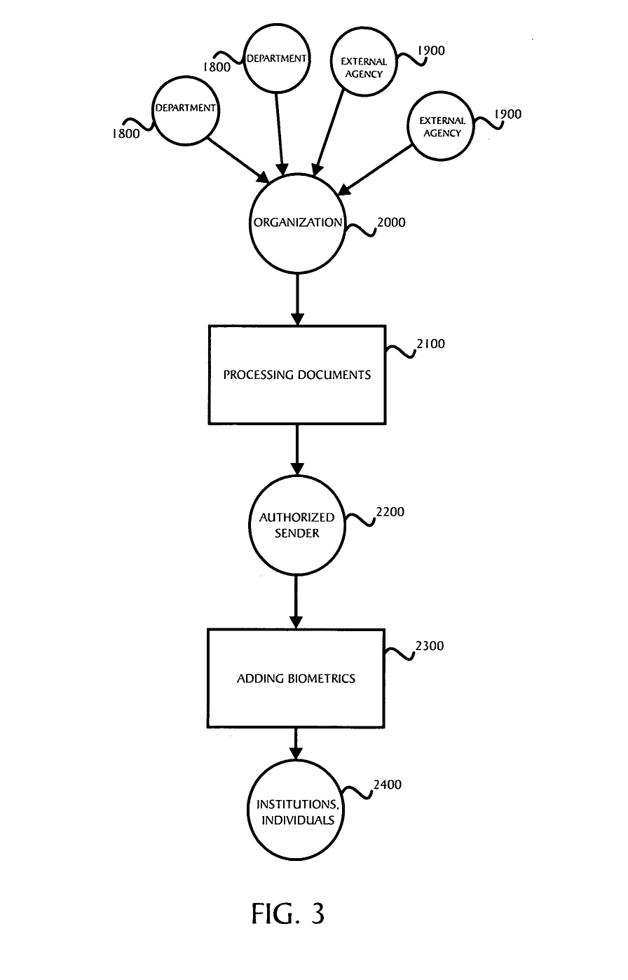

FIG. 3 shows another role based high-level block diagram of the method of the present invention. A cluster of departments 1800 and a cluster of external agencies 1900 associated with an organization 2000 submit documents and reports. These documents received from departments 1800 and external agencies are processed (2100) and scanned by an appropriate authority in the organization before moving the documents forward. The documents are then submitted accompanied by a list of these documents to an authorized sender 2200 who is authorized to release the documents to authorized receivers. The authorized sender 2200 signs each document after verifying that it is enlisted in the document list and adds a biometric mark (2300) to each document before they are sent to authorized receivers, which may be either institutions or individuals (2400). The authorized receivers send back the documents to the organization 2000 so that the genuineness of the documents is verified against the biometric mark. Thus, the genuineness of documents that are in circulation can be established and appropriate action can be taken.

The foregoing description of the preferred embodiments of the present disclosure has been presented for the purpose of illustration and description. It is not intended to be exhaustive or to limit the invention to the precise form disclosed. Many modifications and verifications are possible in light of the above teaching. It is intended that the scope of the invention be limited not by this detailed description, but rather by the claims appended hereto. Since many embodiments of the present disclosure can be made without departing from the spirit and scope of the present disclosure, the present disclosure resides in the claims hereafter appended.

What is claimed is:

1. A sender implemented method of providing biometric security for document, the steps comprising:
scanning a document;
reading and approving the document;
printing the document;
having the document signed by authorized sender;
adding at least one biometric mark on the document by a device provided to the sender; and
sending the document bearing said at least one biometric mark to a receiver.

2. The method of claim 1, further comprising the step of:
having the document sent to receiver returned from a third party; and
scanning the document for the biometric mark to verify the veracity of the document and the receiver.

3. The method of claim 1, further comprising the step of:
having the document sent to the receiver returned from the receiver; and
scanning the document for the biometric mark to verify the veracity of the document and the receiver.

4. A signer-implemented method of avoiding fraudulent checks using biometric marks, the steps comprising:
scanning, reading and approving an invoice;
printing a check of a bank for the approved invoice;
having the check signed by an authorized signatory;
adding at least one biometric mark on the check by a device provided to the authorized signatory; and
sending the check to a receiver.

5. The method of claim 4, further comprising steps of:
having the check sent to the receiver returned from the bank; and
scanning the check for the biometric mark to verify the veracity of the check.

6. A sender implemented method of providing biometric security for document, the steps comprising:
receiving a document from a document sender;
scanning the document;
reading and approving the document;
having the document signed by authorized sender;
adding at least one biometric mark on the document by providing the sender with a device for adding the at least one biometric mark; and
sending the document to a receiver.

7. The method of claim 6, further comprising the step of:
having the document sent to the receiver returned from receiver; and
scanning the document for the biometric mark to verify the veracity of the document and the receiver.

8. The method of claim 6, wherein the document is a diskette.

9. The method of claim 6, wherein the document is a magnetic tape.

10. The method of claim 6, wherein the document is a paper document.

11. A sender implemented system for providing biometric security for document, comprising:
a scanner for scanning a document;
the scanned document being read and approved;
a printer for printing the read and approved document;
the document being signed by authorized sender;
a device for adding at least one biometric mark for adding at least one biometric mark on the document that is provided to the sender; and
the document bearing said at least one biometric mark being sent to a receiver.

12. The system of claim 11 further comprising:
the document sent to the receiver being returned from receiver; and
the scanner scanning the document for the biometric mark to verify the veracity of the document and the receiver.

13. The system method of claim 11 wherein the document is a diskette.

14. The system of claim 11, wherein the document is a magnetic tape.

15. The system of claim 11 wherein the document is a financial instrument.

16. The system of claim 11, wherein the document is a paper document.
